(19) United States
(12) Patent Application Publication
(10) Pub. No.: US 2011/0085667 A1
(43) Pub. Date: Apr. 14, 2011

(54) VARIOUS METHODS AND APPARATUSES FOR SECURING AN APPLICATION CONTAINER

(75) Inventors: JESUS MANNY BERRIOS, SAUSALITO, CA (US); HENRY WONG, SAUSALITO, CA (US); JOHN UNDERWOOD, MILL VALLEY, CA (US)

(73) Assignee: ADGREGATE MARKETS, INC., SAN FRANCISCO, CA (US)

(21) Appl. No.: 12/900,359

(22) Filed: Oct. 7, 2010

Related U.S. Application Data
(60) Provisional application No. 61/250,435, filed on Oct. 9, 2009.
(60) Provisional application No. 61/331,958, filed on May 6, 2010.

(51) Int. Cl. H04L 9/08; G06F 9/44; G06F 15/16

(52) U.S. Cl. 380/282; 717/168; 719/328; 709/203

(57) ABSTRACT

A method, apparatus, and system for securing internet applications including a first internet application hosted on a source server and stored on a physical storage medium of the source server. The internet application is served across a network onto a client machine and contains code scripted to temporarily install on the client machine. The internet application shell container contains code scripted for a user interface to solicit sensitive data from a user of the client machine and a dual encryption security system including. A security communication manager employs an encrypted protocol where the identity of both a sender and a receiver of the transmitted data are both authenticated and the authentication between the client and source server is bilateral. Additionally, the security communication manager transmits the solicited sensitive data from the user interface by cooperating with the encryption engine. The systems and methods can identity theft and fraudulent activity.

### RELATED APPLICATIONS

This application claims the benefit of both U.S. Provisional Patent Application Ser. No. 61/250,435, filed Oct. 9, 2009 and entitled “VARIOUS METHODS AND APPARATUSES FOR SECURING PORTABLE APPLICATIONS,” and U.S. Provisional Patent Application Ser. No 61/331,958, filed May 6, 2010 entitled “VARIOUS METHODS AND APPARATUSES FOR MANAGING AND SECURING A DISTRIBUTED APPLICATION CONTAINER.”

### NOTICE OF COPYRIGHT

A portion of the disclosure of this patent document contains material that is subject to copyright protection. The copyright owner has no objection to the facsimile reproduction by anyone of the interconnect as it appears in the Patent and Trademark Office Patent file or records, but otherwise reserves all copyright rights whatsoever.

### BACKGROUND

Companies may add transactional functionality to rich media advertising banners, web widgets, social media applications, and mobile device applications. As these transactions will inherently involve the consumer's confidential data (e.g., name, address, credit card number, email address); these portable transactional applications should implement a security system. The security system should be sufficient to achieve a level of security similar to that currently achieved by typical secure websites, yet a system tailored to the unique nature of distributed or portable applications which may be embedded in or a component within an otherwise insecure environment.

### SUMMARY OF THE INVENTION

Various methods and apparatus including a system for securing internet applications comprising or a distributed application container are provided.

In an embodiment, an example apparatus may include a first internet application hosted on a source server and stored on a physical storage medium of the source server. The internet application can be served across a network onto a client machine and the internet application can contains code scripted to temporarily install on the client machine.

In an embodiment, the internet application shell container may contain code scripted for a user interface to solicit sensitive data from a user of the client machine. An example system may include a dual encryption security system with an encryption engine for a cryptographic protocol that provides security for communications over networks by encrypting transmitted data from the communication and a security communication manager.

An example security communication manager may employ an encrypted protocol where the identity of both a sender and a receiver of the transmitted data are both authenticated. The authentication between the client and source server can be bilateral. Additionally, the authenticity of the source server identity deploying the internet application to a client browser may be authenticated as an authorized source server identity and the integrity of the internet application as displayed in the client browser on the client machine can be authenticated by the source server.

In an embodiment, the security communication manager may be further configured to transmit the solicited sensitive data from the user interface by cooperating with the encryption engine in accordance with the dual encryption security system. For example, the dual encryption system may ensure the integrity of the client-server communication steps and data collection processes between the internet application and the authentication source by preventing at least identity theft and fraudulent activity. In an embodiment, the systems can allow a mechanism for embedding a secure communications with and identity of an embeddable internet application on an unsecure website.

### BRIEF DESCRIPTION OF THE DRAWINGS

The drawings refer to embodiments of the invention in which:

FIG. 1 illustrates a block diagram of an example computer system that may use an embodiment of one or more of the software applications discussed herein.

FIG. 2 illustrates a network environment in which the techniques described may be applied.

FIG. 3 illustrates a block diagram of an example portable application authentication process.

FIG. 4 illustrates a block diagram of an example secure API communication flow.

FIG. 5 illustrates a block diagram of another example of a portable application security container method.

FIG. 6 illustrates an example secure internet application system communication flow.

FIG. 7 illustrates an example secure internet application system application stack.

FIG. 8 illustrates a block diagram of an example embodiment of a server to display an intelligent device on a portion of a media space, such as a web page, and complete a transaction with the intelligent widget and not leave the webpage that the intelligent device is embedded in.

FIG. 9 illustrates a block diagram of an example embodiment of the intelligent device embedded as part of the web page so that a user from a client machine can complete a transaction securely with code scripted entirely within the intelligent device and not leave the web page that the intelligent device is presented on.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific routines, named components, connections, internet application and security technology, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

Some embodiments relate to a system and method for a system that secures an application container or securing portable applications used in transactional activities. An embodiment may include a comprehensive system for architecting and deploying internet applications in a manner that ensures the authenticity of source deploying the internet application, the integrity the internet application as displayed in the browser of the client machine, and the integrity of the client-server communication.

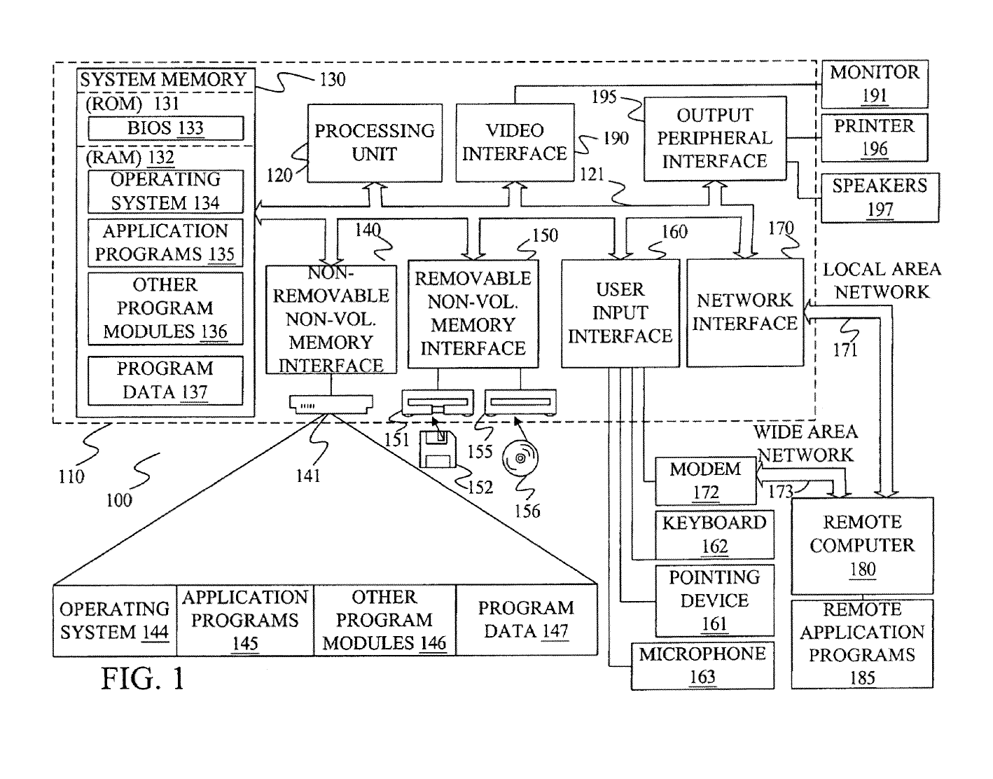

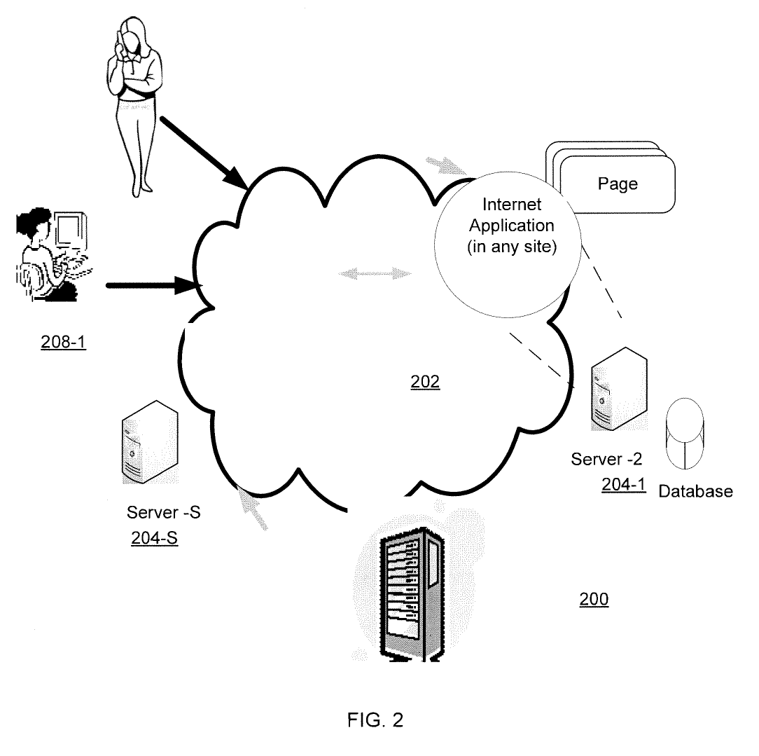

Some embodiments may provide the ability to secure internet applications to enable such applications to transmit sensitive data (e.g., purchase transactions) in a manner that provides end users with sufficient protection from malware, viruses, identity theft, and other fraudulent activity. One illustrative environment in which the embodiments can be used will be discussed in FIGS. 1 and 2.

An embodiment may include features such as a first internet application hosted on a source server and stored on a physical storage medium of the source server. Additionally, the internet application may serve across a network onto a client machine. The application can also contain code scripted to be temporarily installed on the client machine.

In an embodiment, the internet application shell container may contain code scripted for a user interface to solicit sensitive data from a user of the client machine. Some example systems may also include a dual encryption security system. Such a dual encryption security system may include an encryption engine for a cryptographic protocol that provides security for communications over networks by encrypting transmitted data from the communication and a security communication manager.

In an embodiment, the security manager can employ an encrypted protocol where the identity of both a sender and a receiver of the transmitted data are both authenticated. The authentication between the client and source server can be bilateral. Additionally, the authenticity of the source server identity deploying the internet application to a client browser can be authenticated as an authorized source server identity. Further, the source server can authenticate the integrity of the internet application as displayed in the client browser on the client machine.

In an embodiment, the security communication manager can be further configured to transmit the solicited sensitive data from the user interface by cooperating with the encryption engine in accordance with the dual encryption security system. The dual encryption security system can ensure the integrity of the client-server communication steps and data collection processes between the internet application and the authentication source by preventing at least identity theft and fraudulent activity. Additionally, the systems may allow a mechanism for embedding a secure communications with and identity of an embeddable internet application on an unsecure website.

Today, internet applications mostly focus on distributing content and enabling user interaction that does not involve the transmission of sensitive or confidential data. A secure internet application could enable the distribution of purchase transactions, registrations and other activities where end users are transmitting sensitive or confidential data.

FIG. 1 illustrates a computing device 110, such as a computer, PDA, iPhone, etc. with a resident browser application in which the techniques described may be applied. More details are described below.

FIG. 2 illustrates a network environment 200 in which the techniques described may be applied. The network environment 200 has a network 202 that connects S number of servers 204-1 through 204-S, and C number of clients 208-1 through 208-C. More details are described below.

A standardized security mechanism for the unique nature of distributed, i.e. portable, applications, which may be embedded in or a component within an otherwise insecure environment is described. An embodiment implements a series of technical obstacles to prevent forging, or manipulating, the data within portable transactional applications in addition to any security measures taken to secure the transmission of the data. The obstacles include hash matching completed in a three-way handshake between the portable application, a security vendor, and the source of the portable application. The obstacles are implemented in a manner in which a trusted third-party security vendor can participate in the handshake in order to verify the source and then display, within the portable application, a consumer-facing graphical indicator of such security.

An embodiment provides a standardized security for portable transactional applications (e.g., web widgets, intelligent transactional widgets, rich media display advertisements, social network applications) that access the Internet and can be located on (or “served into” or “distributed via”) secure and non-secure websites, applications and platforms (including social networks and mobile devices such as the iPhone). The methodology of an embodiment prevents the forgery of, and manipulation of data within the portable transactional applications.

An embodiment can address at least three primary technical challenges in fighting forgery of applications or manipulation of data within portable applications, which typically embed in non-secure environments:
1. The ability to authenticate that the portable application was delivered to the client browser from an authentic source.
2. The ability to verify the integrity of the portable application as displayed in the client browser.
3. The ability to authenticate the communication steps and data collection processes between the portable application and the authentication source. In the case where this is communicated through an API, the API itself would also have some customary security controls consistent with non-portable applications.

For example, an apparatus may include a system that authenticates that the first internet application was delivered to the client browser from an authentic source. The system can further verify the integrity of the first internet application as displayed in the client browser. Additionally, the system may authenticate the communication steps and data collection processes between the first internet application and the authentic source. In the case where this is communicated through an API, the API itself would also have customary security controls consistent with non-portable application.

Furthermore, an embodiment may solve these challenges in a manner that minimizes disruption to the user experience and is consistent with near real-time displaying of portable applications.

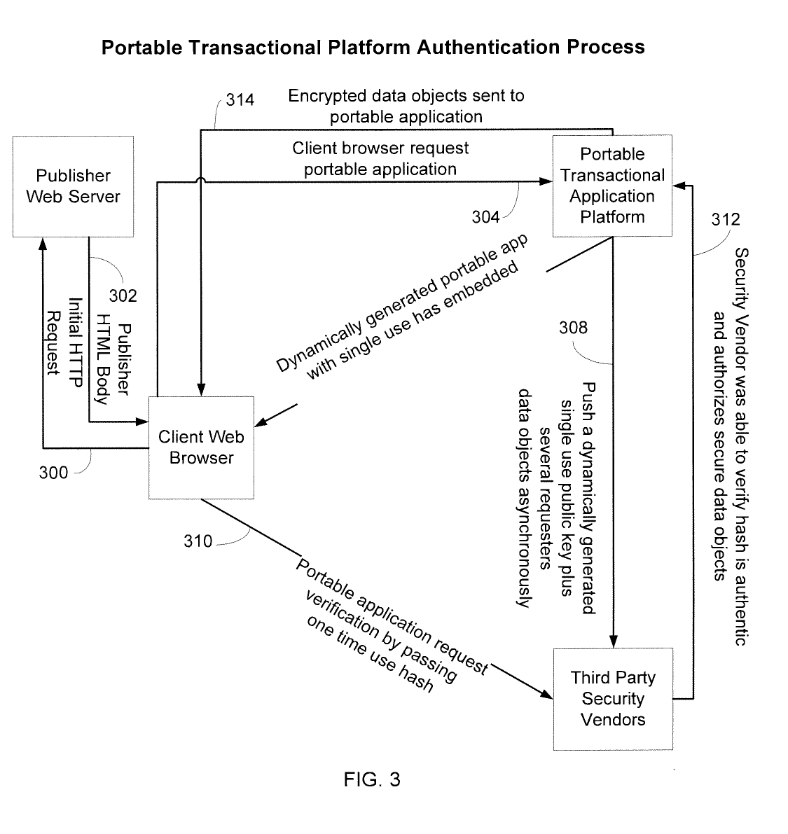

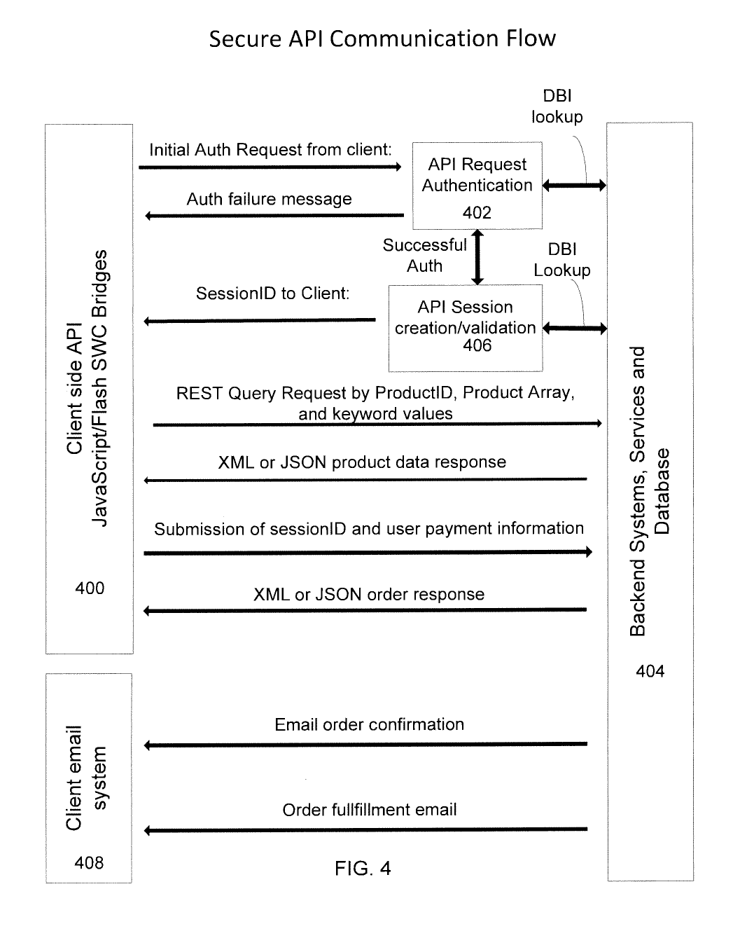

An embodiment can specifically solve these challenges by creating a series of obstacles to forgery of, and manipulation of data within, portable applications. The obstacles as discussed include presenting a variable number of third-party authentications, a combination of randomly selected obstacles (hash), unique identifiers and optionally a third party web site security seal verifying the integrity of hosted portable application pages. The authentication of the communication of data would be in addition to any actual encryption of such data transmission (e.g., via use of SSL). The application shell container may also have additional security features itself. For example, the internet application shell container may contain code scripted for a user interface to solicit sensitive data from a user of the client machine. The system might include a trusted third party brand/auditing vendor who participates in creating a security seal for trusted publishers using a portable application. Such vendor could participate in a three-way handshake and authentication implemented as follows in FIGS. 3 and 4.

An example portable application authentication process is shown in FIG. 3, which illustrates an example third party server storing some of the private keys or unique signature information for the validation, verification, and authorization steps. Note, step numbers indicate the linear request/response flow and this sequence can change.

Referring now to FIG. 3, in step 300, a publisher's web server hosting a portion of the portable application receives an initial HTTP request from a client machine's web browser over an unsecure communication channel. The publisher's web server sends the publisher HTML body to the client machine's web browser over an unsecure communication channel, step 302. In an embodiment, the HTML body may contain the HTML content, less the body tags themselves. The HTML body may convey all the standard elements of an HTML document. Thus, the source server implementing the distributed portable application accepts a request from any client browser to deliver a portable application as part of the HMTL document and includes a routine to perform the one-time hash match.

The client machine's web browser sends a client browser request for another portion of the portable application to the portable transactional application platform creating instances of the portable application in step 304. The portable transactional application platform sends a dynamically generated portable application with a single use hash embedded to the client machine's web browser in step 306. Upon a successful match, such a source creates two unique hash keys (keys may be of known or proprietary standards and functionality (e.g., keys may expire after a certain period of time, etc)) in step 308.

The portable transactional application platform also pushes a dynamically generated single use public key plus several requesters' data objects asynchronously to one or more third party security vendor(s) in step 310. Thus, asynchronously, such source creating instances of the portable application dynamically incorporates one key into the portable application and securely sends the other key to a respected third-party brand/audit vendor.

Upon the execution/compilation of the portable application on the client browser, the portable application submits to the third party the hash key, which is authenticated against the key provided by the source. Note, authentication may also include any randomly selected process such as check-sum or other custom algorithm selected at random from a set of possible algorithms. Thus, the client machine's web browser sends portable application request verification by passing the one time use hash function to the third party security vendor(s).

The third party security vendor(s) then communicate that the security vender was able to verify the hash and thus is authentic and authorizes secure data objects to the portable transactional application platform in step 312. Thus, upon a successful match the third-party security vendor performs two functions. First, the third-party security vendor issues a key that provides a missing component of code or that in turn enables the portable application to complete an argument or routine that enables the portable application to perform properly. Secondly, the third party issues a certification or other visual representation that the transaction is indeed certified as secure. The certification can have any desired meaning or communication conveying security (e.g., branded logo, time stamp, transaction control number, etc.) and may be delivered separately as a certificate or seal. The portable transactional application platform then passes encrypted data objects back and forth between itself and the client machine's web browser to complete the transaction in secure communication channels, step 314.

In an embodiment, upon a successful match of the sender and receiver ID's via an SSL protocol, the server system or third party security vendor performs two functions. First, in the second embodiment, the server system or the third-party security vendor issues a key that provides a missing component of code or that in turn enables the portable internet application to complete an argument or routine that enables the portable internet application to perform properly. In the first embodiment, the application generates its own signature key, authenticates, and reloads in the memory used by the browser, and then sends its initiation communication to the security server for verifying the integrity of the first internet application as displayed in the client browser. In both cases, the portable internet application has the address of the security server to call to and establish SSL tunnel type communications. Secondly, the server system or the third party may issue a certification or other visual representation that the transaction is indeed certified as secure. The processing platform then passes encrypted data objects back and forth between itself and the client machine's web browser to complete the transaction in secure communication channels. In an embodiment, only the user sensitive data is passed as encrypted data objects in order to speed of communications between the server and the client. An RSA type of encryption program does not encrypt regular public information. Thus, the system authenticates the communication steps and data collection processes between the first internet application and the authentic source.

In an embodiment, a third party vendor can be involved in the validation. An example secure API communication flow is illustrated in FIG. 4. The figure illustrates an example of additional steps that may be used for communication flow for an e-commerce transaction internet application. The client side API module 400 may use JavaScript/Flash or other similar language. The client side API 400 sends an initial authorization request from the client to the API request authentication module 402 within the portable application, such as an intelligent transactional widget. The API request authentication module 402 communicates with the creation source of the portable application such as backend systems 404. Additionally, the API request authentication module 402 communicates with services and a database to do a database look up and check. The API request authentication module 402 sends one of two messages to the browser of the client machine depending on the validity check with the creation source of the portable application. The API request authentication module 402 sends an Authentication failure message to the Client side API module 400, if appropriate. The API Request Authentication module 402 sends a positive authentication success message to the API Session creation/validation module 406, if appropriate. The API Session creation/validation module 406 also communicates a database look up the Backend Systems, Services, and Database 404 to obtain a session ID, if the validation was successful. The API Session creation/validation module 406 receives, logs, and passes the session ID to the client side API module 400. The Client side API module 400 sends a REST query request by productID, Product Array, and keyword values to the backend systems, services and database 404.

The REST-Query requests may be simple HTTPS requests calling for service actions, using the GET or POST method, with query parameters in the URL. The REST-Query requests can contain an Action parameter to indicate the action to be performed. The backend systems, services and database 404 sends a XML or JavaScript Object Notation (JSON) product data response back to the client side API module 400. The client side API module 400 sends a submission of sessionID and user's private information including payment information to the backend systems, services, and database. The backend systems, services, and database 404 send one or more ordered responses in XML or JSON to the client side API module 400. The backend systems, services, and database 404 also send an e-mail order confirmation to the client machine's resident e-mail system. After completion, the backend systems, services and database 404 will send an e-mail order fulfillment notice to the client machine's resident e-mail system 408 when the order has been fulfilled.

An embodiment enables portable transactional applications to transmit confidential transactional data in a secure manner, which in turn establishes the level of consumer trust necessary for consumers to transact in portable applications. Thus, the embodiment implements a series of technical obstacles for preventing forging or manipulating the data within portable transactional applications in addition to any security measures taken to secure the transmission of the data. The obstacles include hash matching completed in a three-way handshake between the portable application and the source of the portable application. The obstacles are implemented in a manner in which a trusted third party can participate in the handshake in order to verify the source and then display, within the portable application, a consumer-facing graphical indicator of such security.

For example, in an embodiment, the source server implementing the distributed portable internet application accepts a request from any client browser to deliver a portable internet application as part of the HMTL document and includes a routine to perform the one-time hash match. Through a protocol that verifies both the identity of the server and client machine and subsequent look up in the memory of the security server, the system authenticates that the first internet application was delivered to the client browser from an authentic source. The client machine's web browser sends a client browser request for another portion of the portable internet application to the processing platform creating instances of the portable application. The processing platform, for example, a web servicing system based on grid and cloud architecture, can send a dynamically generated portable internet application with a single use hash embedded to the client machine's web browser.

The portable internet application in one embodiment self generates its own unique signature to unlock the executable code of the portable internet application via unreadable metadata sent with the portable internet application and the self generated unique signature will match up to a valid signature stored in a table in the server. The portable internet application in one embodiment self generates its own unique signature to unlock the executable code of the portable internet application via unreadable metadata sent with the portable internet application and the self generated unique signature will match up to a valid signature stored in a table in the server. The portable internet application in another embodiment a random key generator sends a unique signature along with the executable code of the portable internet application to unlock the executable code of the portable internet application and the issued generated unique signature will match up to a valid signature stored in a table in the server. The self generated key or issued randomly generated key harden the binary code for authentication of the portable internet application to ensure no one has altered the code of the portable application. The portable internet application sends an initial communication to the server for an authentication match, such source creates two unique hash keys (keys may be of known or proprietary standards and functionality (e.g., keys may expire after a certain period of time, etc)). Thus, the system verifies the integrity of the first internet application as displayed in the client browser.

Upon a successful match, the processing platform also pushes a dynamically generated single use public key plus several requesters' data objects asynchronously to one or more third party security vendor(s) or the security server. Thus, asynchronously, such source creating instances of the portable internet application dynamically incorporates one key into the portable internet application and securely sends the other key to a respected third-party brand/audit vendor.

In an embodiment, upon the execution/compilation of the portable internet application on the client browser, the portable internet application submits to the third-party the hash key, which is authenticated against the key provided by the source. Thus, the client machine's web browser sends a portable internet application request verification by passing the one time use hash function to the server system or the third party security vendor(s). The server system or the third party security vendor(s) then communicate that the security vender was able to verify the hash and thus is authentic and authorizes secure data objects to the processing platform.

In an embodiment, one example system generally relates to internet applications. internet applications are generally web applications that have many of the characteristics of computer desktop and mobile applications, and are typically delivered either by way of a site-specific browser, via a browser plug-in, or independently via sandboxes or virtual machines. Adobe Flash, Java and Microsoft Silverlight may be three example frameworks for the internet applications. Users generally need to install a software framework using the computer's operating system before launching the internet application, which typically downloads, updates, verifies, and executes the internet application. In an embodiment, a client portion of the internet applicant resides within a special isolated area of the client desktop called a browser security sandbox.

The sandbox limits visibility and access to the file-system and to the operating system on the client to the application server on the other side of the connection. This approach allows the client system to handle local activities, calculations, reformatting and so forth, thereby lowering the amount and frequency of client-server traffic. This is a differentiator from JavaScript-based alternatives like Ajax, which use built-in browser functionality to implement comparable interfaces.

In an embodiment, a first internet application hosted on a website or social media page of a server and stored on a physical storage medium of the server. The internet application, upon request by a browser of a client machine, can be served across a network onto a client machine. In an embodiment, the internet application may contain code scripted to temporarily install on the client machine where the internet application is complied by an interpreter application, such as adobe flash, for a browser application at run time and then uninstalled when the browser application is closed.

For security purposes, the internet applications can run their client portions of that Application within a special isolated area of the client machine called a sandbox. Security improves for the internet applications through use of sandboxes and automatic updates. The sandbox limits visibility and access to the file-system and to the operating system on the client machine to the application server on the other side of the connection. This approach allows the client system to handle local activities, calculations, reformatting and so forth, thereby lowering the amount and frequency of client-server traffic, especially as compared to the client-server implementations built around so-called thin clients.

An embodiment generally provides the ability to secure internet applications to enable such applications to transmit sensitive data (e.g., purchase transactions) in a manner that provides end users with sufficient protection from malware, viruses, identity theft, and other fraudulent activity.

Today internet applications mostly focus on distributing content and enabling user interaction that does not involve the transmission of sensitive or confidential data. A secure internet application could enable the distribution of purchase transactions, registrations and other activities where end users are transmitting sensitive or confidential data.

### Portable Application Security Container Method

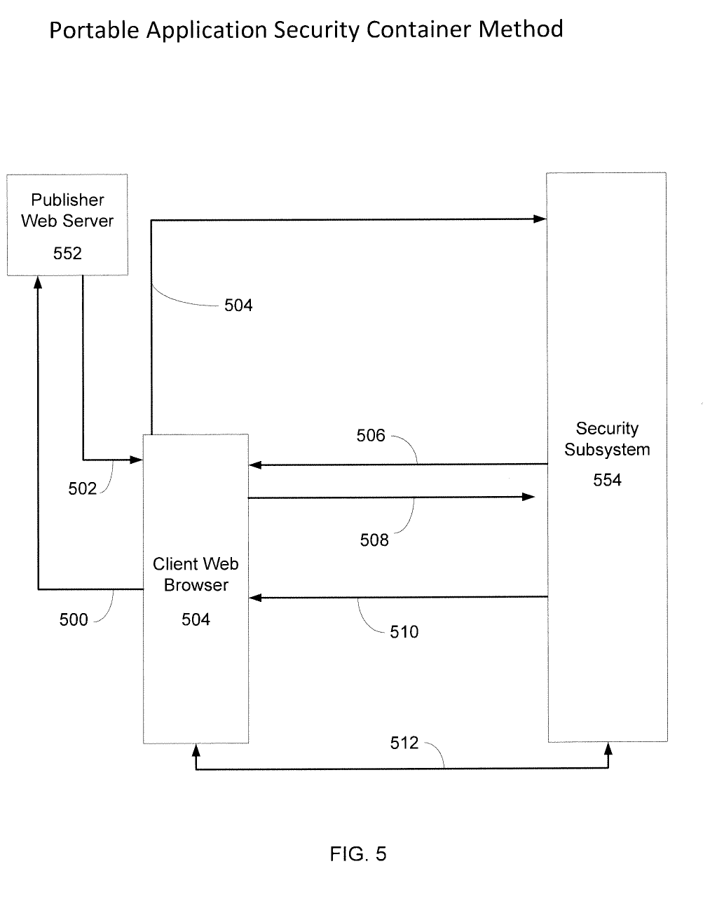

FIG. 5 illustrates a portable application security container method. An embodiment has a client-server architecture and software system consisting of the following integrated components, which have not previously been deployed within a single internet application. The system may architect and deploy one or more internet applications in a manner that ensures the authenticity of source deploying the internet application, the integrity the internet application as displayed in the browser of the client machine, and the integrity of the client-server communication.

In an embodiments, certificate based secure socket layer communication is a kind of cryptographic protocol that provides security for communications over networks such as the Internet. Secure socket layer and other types, such as transport layer security encrypt the segments of network connections at the transport layer end-to-end. The secure socket layer authentication can be bilateral. In other words, the server is authenticated (the client knows the server's identity), and the server authenticates the client.

RSA Encryption for client/server communication RSA may include an algorithm for public-key encryption. The RSA algorithm involves three steps: key generation, encryption, and decryption. RSA involves a public key and a private key/hash. The public key can be known to everyone and is used for encrypting messages. Messages encrypted with the public key can only be decrypted using the private key/hash.

Additionally, authentication for API access may include an application programming interface (API) that can be an interface implemented by a software program to enable its interaction with other software. Further, some embodiments can include code signature authenticity validation.

In an embodiment, the security communication manager may use a secure socket layer communication protocol and the encryption engine uses a RSA Encryption public-private key mechanism or Blowfish or other types of encryption. In some example systems, an encryption engine for a cryptographic protocol may provide security for communications over networks by encrypting only the transmitted sensitive data by employing an information scrambling type of encryption protocol.

Some example steps in the diagram are as follows. First, the client web browser 550 makes an initial HTTP request 500 to the publisher web server 552 and the publisher web server 552 sends a publisher HTML body 502. Second, the client web browser 550 requests 504 a portable application from the security subsystem 554. Third, the security subsystem 554 dynamically generates a portable application with a single use hash injected 506 during run time and provides the portable application to the client web browser 550. Fourth, the client web browser 550 sends a portable application request verification by passing a one-time use hash and single use public key and several requesters data objects asynchronously 508. Communications (500, 502, 504, 506, 508) in steps 1-4 may be sent using unsecure communication channels. In a fifth step, if the security subsystem 554 is able to verify that the hash is authentic, it can authorize secure data objects 510. In a sixth step, with secure data objects authorized 510 encrypted data objects may be sent to the portable application 512. Encrypted data objects may be sent between the client web browser 550 and the security subsystem 554.

The system may achieve (1) authentication that the internet application was delivered to the client browser from an authentic source; (2) verification that the integrity of the internet application as displayed in the client browser, (3) authentication that the communication steps and data collection processes between the internet application and the authentic source. In the case where this is communicated through an API, the API itself would also have customary security controls consistent with non-portable applications.

An internet application designed and deployed using an embodiment may operate as follows, first, the server initiates an encrypted server-to-client communication channel using, for example, RSA 384-bit public-key encryption. Second, the internet application initiates an encrypted client-to-server communication channel using, for example, RSA 1024-bit public-key encryption. Third, the server generates a cryptographic hash unique to the internet application and injects such hash into the internet application file (for example, the small web format file). Forth, after the internet application is rendered in the client, the system matches the cryptographic hash within the rendered internet application to the hash originally generated by the server. Fifth, to secure against any data manipulation in real-time, the client transmits the server side encryption public key back to the server in each message.

### Secure Internet Application System Communication Flow

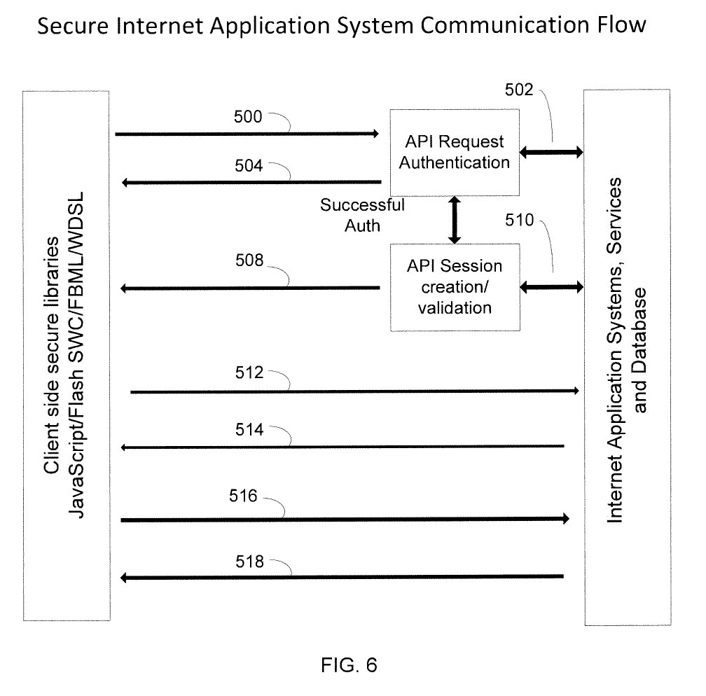

FIG. 6 illustrates a secure internet application system communication flow. Some example steps of in the diagram may include the Client Side Secure Libraries (JavaScript/Flash SWC/FBML/WDSL) making an initial hash and RSA authentication request (GETSEsession) to the API Request Authentication 600. The API request authentication can perform a memory cache lookup with the internet application system services and database 602. Additionally, the API Request Authentication may transmit an authentication failure message to the client side secure libraries, e.g., when an authentication failure occurs 604. A successful authentication message can be transmitted between the API request authentication and the API session creation/validation., e.g., when an authentication is successful 606. The API session creation/validation transmits the SessionID to the client, e.g., client side secure Libraries 508.

Additionally, the API session creation/validation can perform a memory cache lookup with the internet application system services and database 610 and the client side secure libraries can transmit a secure query request by product ID, product array, and keyword values to the internet application system services and database 612. The internet application system services and database may also transmits an XML or JSON product data response to the client side secure libraries 614.

The client side secure libraries transmits a submission of sessionID and user payment information to the internet application System Services and Database 616 and the internet application system services and database transmits a XML or JSON order response to the Client Side Secure Libraries 618. Communications in steps 600, 602, 512, and 514 might use unsecure communication channels, while communications in steps 508, 516, and 518 might use secure communication channels.

As illustrated in FIG. 6 the top two arrows 600, 602 correspond to step 504 of FIG. 3 for the authentication portion. Additionally, the bottom two arrows 604, 606 correspond to step 512 of FIG. 3 for the SSL tunnel and RSA encrypted data transmission portion. The two arrows above that 608, 610 correspond to step 508 for only SSL tunnel security for non-sensitive data transmission. In an embodiment, the security stack box corresponds to the creation application on the secure server, which creates and deploys internet applications. Additionally, the security container box can refer to modules within the portable internet application itself.

In addition, in an embodiment, due to the dual security system employed in the communications of between the portable application and the secure server, many intelligence routines can be built into the portable application. Once authenticated, verified, and validated, the application can call the secure server on any number of possible reasoning tasks and receive guidance from the secure server. The secure server may be a list of authorized servers associated with an organization or partners of the organization.

Thus, in an embodiment, the portable internet application verifies its self-generated signature of what that signature is supposed to be to unlock the executable portion of that portable internet application in the browser of the client device. Next, SSL verifies the identities of the security server and the client device. The portable internet application also sends its self-generated unique signature to the security server to be verified. If these do not match then the communication does not proceed. Next, during communications between the portable internet application and the secure server, then RSA type of encryption may be used to further secure sensitive data transmitted over the network. In order to deploy the system, the internet application can be designed and developed to include a detailed security stack.

### Detailed Security Stack

During Initial Build (developer side), communication and authentication code library may be added to the target internet application file (e.g., small web format file). As an additional optional measure, provided public back-end key can be stored within small web format (e.g., 1024-bit RSA key), then back-end can generate a new key pair each time for added security, however it would require re-compilation of the small web format each time it's accessed. Additionally, after small web format compilation, the public back-end key can be sent to back-end to register it within the system, preferably uncompressed to save some CPU cycles on the injection part.

During small web format Registration to the system (back-end side) meta data is injected into a small web format that will be served. This Meta data will not be accessible from anywhere unless the small web format is decompressed and loaded in a hex editor. Meta data can be encrypted thus making it impossible for anyone except the system's back-end to read it. Meta data can be used as an authentication method, it's injected to provide unique hashes for same small web formats used and registered by different clients. Meta data can include Application ID—small web format Application ID; Developer ID—Developer key; and additionally, more fields can be added as needed.

Injected small web format can be compressed if needed and stored for further delivery. This can result in a small web format is hashed and registered in database (making it available for download/load). Additionally, any hashing algorithm can be used, but it is preferable to use MD5 due to speed considerations on the front end.

During flash runtime (client side), after the base small web format is loaded (a small web format containing authentication and communication code library) the small web format may re-loads itself from browser cache as binary stream. Small web format hashes itself and stores for further reference. Additionally, small web format generates its own set of public/private keys (e.g., 384-bit RSA key). Additionally, to secure against ‘Man in the Middle’ attacks, small web format makes a session request from back-end while sending its own public key—encrypted with back-end public key and its own hash—encrypted with back-end public key.

After back-end checks for validity (encryption) and authenticate the small web format (checking its hash), the system creates the client-server session. Further communication is selectively encrypted—only private parts of communication are encrypted thus making the communication bandwidth and resources efficient.

In an embodiment, the transmitted object from the server that will be complied at runtime into the internet application generates a unique signature/key. The unique signature/key may be derived from 1) embedded metadata, 2) by being reloaded in the browser after the object is complied, and 3) any combination of both. This can allow for the signature to be matched by list of unique signature/keys stored in the server. Additionally, the signature can unlock the executable file of portable application.

### Secure Internet Application System Application Stack

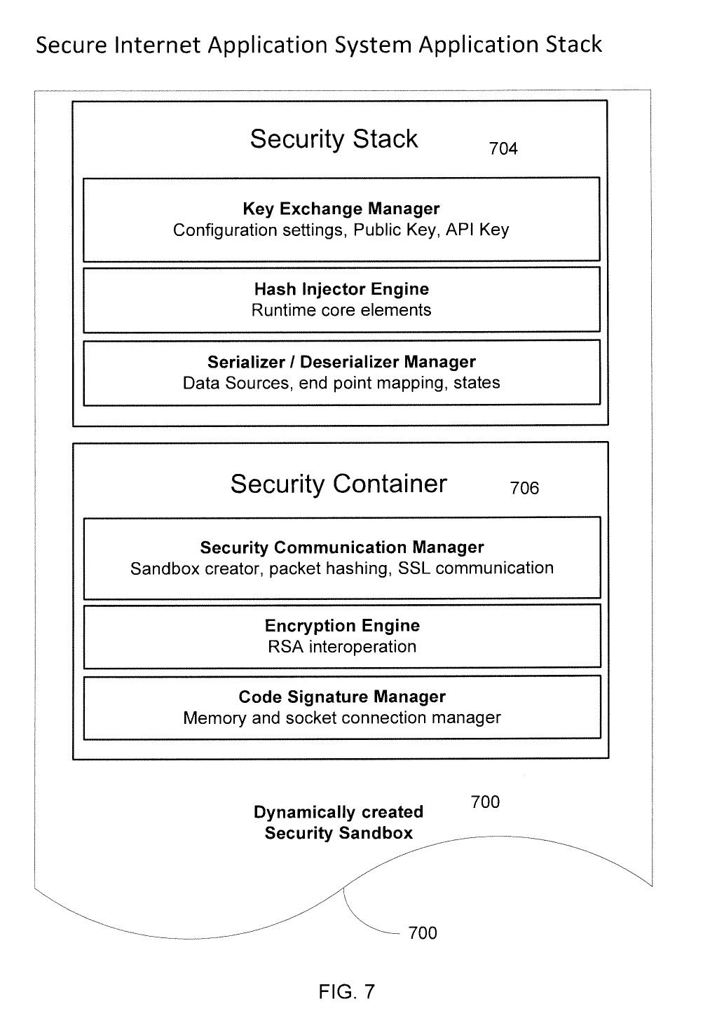

FIG. 7 illustrates a secure internet application system application stack 700. The secure internet application system application stack may include a dynamically created security sandbox 702, which can include a security stack 704 and a security container 706. Some example components in the security stack 704 can include a key exchange manager that may store, e.g., configuration settings, public keys, API keys, etc. Additionally, the hash injector engine may store runtime core elements and the serializer/deserializer manager may store data sources, end point mappings, states, etc.

Some example components in the security container 706 include the security communication manager, which may be the sandbox creator and may manage packet hashing and secure socket layer communication and the encryption engine, which may perform encryption and RSA interoperation. The security container 706 may also include the code signature manager may act as the memory and socket connection manager.

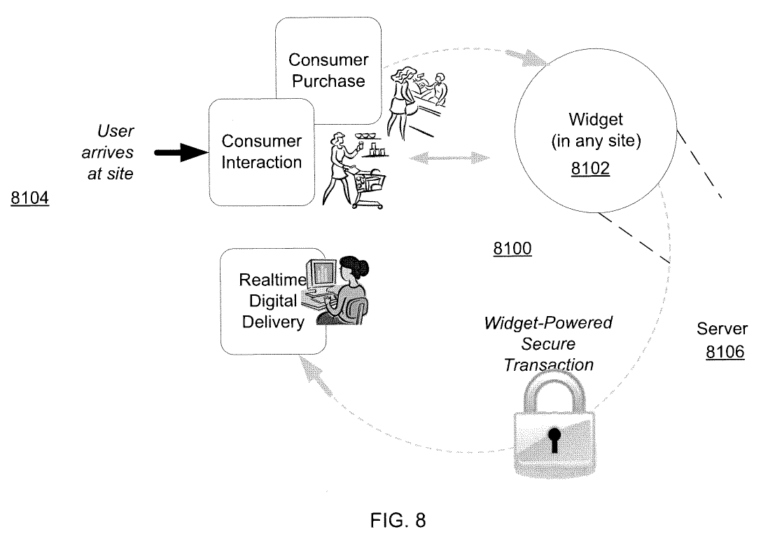

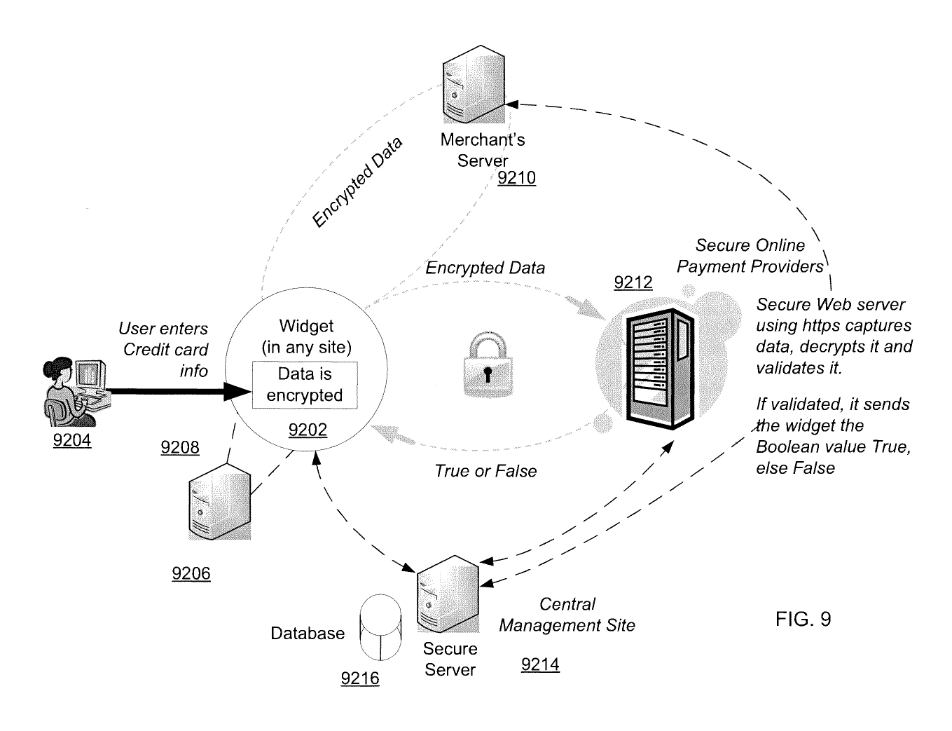

FIG. 8 illustrates a block diagram of an embodiment of a server to display an intelligent widget on a portion of a media space, such as a web page, and complete a transaction with the intelligent widget and not leave the webpage that the intelligent widget is embedded in. The intelligent widget 8102 may be embedded into a third party's media space, such as an HTML web page 8100. A user from a client machine 8104 may interact with the web page 8100 that contains the embedded intelligent widget 8102, and then spot an advertisement presented by a user interface of the widget 8102. The web page may be served by a web server 8106 on any HTML or WAP enabled client device 8104 or any equivalent thereof such as a mobile device or personal computer. The intelligent widget 8102 has code scripted to present fields and icons to take details of a desired transaction, including a product or a service, to be purchased and to complete the transaction including taking payment for the product or service. (See for example FIG. 9.)

The intelligent widget 8102 may be implemented as a targeted advertisement type banner served to a customer and offering the opportunity to engage in a secure transaction that takes place entirely in the screen space occupied by the intelligent widget 8102 and without redirecting the user client machine's browser application to any other pages. Thus, the user may complete payment or fulfillment of the transaction without leaving the original web page.

Typically, the transaction with the user client machine involves the user first selecting a product or service to purchase, such as a hotel booking or donation to a charity. The intelligent widget 8102 then serves pages that allow entry of address details and further pages that allow entry of payment details such as credit or debit card details. Once these details are entered, they are passed to a conventional online payment system as described in more detail below. The online payment system returns status information concerning the transaction and which may then be displayed by the user interface of the widget to provide feedback on success or failure of the transaction to the user.

The transactional widget 8102 may contain code scripted to permit transactions in the transactional widget ad model to be carried out inside the transactional banner presented by the widget 8102. Customers of online e-commerce sites remain within the original site 8100; while the customer can securely buy products and services from a seller without interrupting their overall experience.

As opposed to a static banner advertisement (ad), the intelligent widget 8102 is a web widget and thus may be a portable chunk of code that can be installed and executed within any separate HTML-based web page 8100 by an end user without requiring additional compilation. The transactional widget 8102 may be a module, snippet, plug-in or extension form that adds some advertisement content to that page that is not static and the content may be changed by someone other than the owner of the web page 8100 and may be run when the browser calls the page. The web widget 8102 adds some content to the web page 8100 that is not static.

Another embodiment of the application, which may occur separately or in combination with other embodiments, may include the ability to pass payment information securely from the user to the merchant (transact) and complete a transaction without being dependent on the merchant's site or being required to go the merchant's site. Thus, the encryption software is contained within the widget itself.

Embodiments of the application represented in FIG. 8 may alternatively or in combination include aspects that may take in payment information, pass it out securely (https) for authorization, and bring back a passed (or failed) payment confirmation without the user every leaving the site they are on. Aspects of the application may permit digital delivery for non-physical products. With a platform, publishers may become the agents that power merchants' transactions (rather than being just a vehicle for merchants' branding).

FIG. 9 illustrates a block diagram of an embodiment of the intelligent widget embedded as part of the web page so that a user from a client machine can complete a transaction securely with code scripted entirely within the intelligent widget and not leave the web page that the intelligent widget is presented on.

The intelligent transactional widget 9202 may contain code scripted to permit secure transactions within or inside an online advertising space of a website without leaving to go to another website. A port 9208 is configured on the server 9206 to receive the payment information for the product or service over a network from the client machine 9204. The system also includes a third party payment processing system 9212 and third party merchant services or product servers 9210. The browser of the user client machine 9204 is not redirected so as to leave the web site that the intelligent widget 9202 is presented on during the transaction.

The intelligent widget 9202 has code scripted to interact directly with the one or more of the secure on-line payment providers 9212 rather than interacting with middleware of a transaction management application hosted on another server or other intervening mechanism. The encryption software is contained within the widget 9202 itself. The intelligent widget 9202 can have code to take in payment information. This payment information can including the details of the product or service to be purchased taken from the user and the corresponding payment details of the user. The payment information details of the user information out securely (https) can be passed over a network for authorization with one or more of the online payment providers 9212 and brought back over the network a passed or failed payment confirmation without the user ever leaving the media space (website) that the intelligent widget 9202 is embedded in. The intelligent widget 9202 also has code to then pass payment and product information on the sale of the product or service securely over the network onto the merchant site 9210 hosted on another server without the user ever leaving the web site that the intelligent widget 9202 is presented on. The intelligent widget 9202 also has code to then report payment and product information on the sale of the product or service securely to a central management site 9214.

The widget 9202 may also have code scripted to interact with a number of different types of secure payment providers 9212. The customers may use any number of payment options including general payment options such as credit cards or more proprietary methods such as PayPal. The code for the secure payment tunnels is scripted within the widget 9202 platform itself and can be easily updated by the owner of the widget 9202. The transactional widget 9202 may let the user interact with an eCommerce application on a web page, for example, to buy products, book services, or download digital content, completely within the transactional banner presented by the user interface of the widget 9202.

As discussed, the widget 9202 may include the ability to pass payment information securely from the user to the merchant (i.e. transact) and complete a transaction without being dependent on the merchant's site 9210 or their browser being required to go the merchant's site 9210. Thus, the purchases are made directly within the ad widget 9202. The encryption software is contained within the widget 9202 itself as well as display of products, full functioning shopping cart, encrypted and secure payment processing.

The intelligent widget 9202 has code scripted to transfer sensitive customer information such as downloadable purchases, personal data, and credit card processing over a network to secure sites 9210, 9212, 9214. The intelligent widget 9202 has code, including SSL and HTTPS, for an encryption algorithm to secure sensitive data during the data transfer process. The algorithm encrypts confidential or personal information of a user sent to be processed, can decrypt, and also validate data sent by a user. The intelligent widget 9202 has code scripted to obtain the sensitive customer information from a client machine in secure manner.

When a user submits his/her information on the widget form, a security manager coded in the widget applies its proprietary encryption algorithm to the data prior to transfer via HTTPS to the Company's secure servers. Therefore, the data is “double protected” by the encryption as well as the transfer of the data via HTTPS.

In an embodiment, a dual encryption security system may include a security communication manager. The security communication manager may employ an encrypted protocol where the identity of both the sender and receiver of the transmitted information are both authenticated. The authentication between the client and server can be bilateral. Additionally, the authenticity of the source server identity deploying the internet application to the client browser can be authenticated as an authorized source server identity and the integrity the internet application as displayed in the browser of the client machine may be authenticated by the server.

In an embodiment, the security communication manager may be further configured to transmit the solicited sensitive data (e.g., purchase transactions) from the user interface by cooperating with the encryption engine in accordance with the dual encryption security system. Such a system may ensure the integrity of the client-server communication steps and data collection processes between the internet application and the authentication source by preventing at least identity theft and other fraudulent activity.

FIG. 1 illustrates a block diagram of an example computer system that may use an embodiment of one or more of the software applications discussed herein. The computing system environment 100 is only one example of a suitable computing environment and is not intended to suggest any limitation as to the scope of use or functionality of an embodiment. Neither should the computing environment 100 be interpreted as having any dependency or requirement relating to any one or combination of components illustrated in the exemplary operating environment 100.

An embodiment can be operational with numerous other general purpose or special purpose computing system environments or configurations. Examples of well known computing systems, environments, and/or configurations that may be suitable for use with an embodiment include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments may be described in the general context of computing device executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below.

An embodiment may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary computing type system for implementing an embodiment can include a general-purpose computing device in the form of a computer 110. Components of computer 110 may include, but are not limited to, a processing unit 120 having one or more processing cores, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable mediums uses include storage of information, such as computer readable instructions, data structures, program modules or other data. Computer storage mediums include, but are not limited to, RAM, ROM, EEPROM, flash memory, or other memory technology, CD-ROM, digital versatile disks (DVD) or other optical disk storage. Computer storage medium can also include magnetic cassettes, magnetic tape, magnetic disk storage or other magnetic storage devices, or any other medium which can be used to store the desired information and which can be accessed by computer 100. Communication media typically embodies computer readable instructions, data structures, program modules, or other transport mechanism and includes any information delivery media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media. FIG. 1 further illustrates a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet. A browser application may be resident on the computing device and stored in the memory. A browser application may be resident on the computing device and stored in the memory.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that an embodiment can be carried out on a computer system such as that described with respect to FIG. 1. However, the an embodiment can also be carried out on a server, a computer devoted to message handling, or on a distributed system in which different portions of an embodiment are carried out on different parts of the distributed computing system.

Another device that may be coupled to bus 111 is a power supply such as a battery and Alternating Current adapter circuit. As discussed above, the DC power supply may be a battery, a fuel cell, or similar DC power source that needs to be recharged on a periodic basis. The wireless communication module 172 may employ a Wireless Application Protocol to establish a wireless communication channel. The wireless communication module 172 may implement a wireless networking standard such as Institute of Electrical and Electronics Engineers (IEEE) 802.11 standard, IEEE std. 802.11-1999, published by IEEE in 1999.

Examples of mobile computing devices may be a laptop computer, a cell phone, a personal digital assistant, or other similar device with on board processing power and wireless communications ability. Such devices may be powered by a Direct Current (DC) power source that supplies DC voltage to the mobile device and that is solely within the mobile computing device and needs to be recharged on a periodic basis, such as a fuel cell or a battery.

Referring back to FIG. 2, FIG. 2 illustrates a network environment 200 in which the techniques described may be applied. The network environment 200 has a network 202 that connects S servers 204-1 through 204-S, and C clients 208-1 through 208-C. As shown, several systems in the form of S servers 204-1 through 204-S and C clients 208-1 through 208-C are connected to each other via a network 202, which may be, for example, an on-chip communication network. Note that alternatively the network 202 might be or include one or more of: inter-chip communications, an optical network, the Internet, a Local Area Network (LAN), Wide Area Network (WAN), satellite link, fiber network, cable network, or a combination of these and/or others. The servers may represent, for example: a master device on a chip; a memory; an intellectual property core, such as a microprocessor, communications interface, etc., a disk storage system, and/or computing resources. Likewise, the clients may have computing, storage, and viewing capabilities. The method and apparatus described herein may be applied to essentially any type of communicating means or device whether local or remote, such as a LAN, a WAN, a system bus, on-chip bus, etc. It is to be further appreciated that the use of the term client and server is for clarity in specifying who initiates a communication (the client) and who responds (the server). No hierarchy is implied unless explicitly stated. Both functions may be in a single communicating device, in which case the client-server and server-client relationship may be viewed as peer-to-peer. Thus, if two devices such as 208-1 and 204-S can both initiate and respond to communications, their communication may be viewed as peer-to-peer. Likewise, communications between 204-1 and 204-S, and 208-1 and 208-C may be viewed as peer to peer if each such communicating device is capable of initiation and response to communication.

FIG. 2 also illustrates a block diagram of an embodiment of a server to display the application on a portion of a media space, such as a web page, a profile page on a social network site, etc. The application may be embedded into a third party's media space, such as an HTML web page, a page of a social network platform, etc. The application, when executed on a server 204, causes the server 204 to display windows and user interface screens on a portion of a media space such as a web page. A user from a client machine 208 may interact with the page that contains the embedded application, and then supply input to the query/fields and/or service presented by a user interface of the application. The web page may be served by a web server 204 on any HTML or WAP enabled client device 208 or any equivalent thereof such as a mobile device or personal computer. The client device 208 may host a browser to interact with the server. Each application, widget, Plug in, etc. has a code scripted to perform the functions that the software component is coded to carry out such as presenting fields and icons to take details of desired information. The intelligent application may be implemented as a viral web application hosted on the server and served to the browser of the client machine 208 of the customer. The intelligent application then serves pages that allow entry of details and further pages that allow entry of more details.

An internet application and other scripted code components may be stored on a computer readable medium which, when executed on the server causes the server to display the application on a portion of a media space. The media space may be web pages, social network platforms, etc. hosted on a server. Further websites may be hosted on a server.

In an embodiment, the software used to facilitate the functions and processes described herein can be embodied onto a machine-readable medium such as computer readable medium. As discussed above a computer-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; DVD's, EPROMs, EEPROMs, FLASH, magnetic or optical cards, or any type of media suitable for storing electronic instructions. The information representing the apparatuses and/or methods stored on the machine-readable medium may be used in the process of creating the apparatuses and/or methods described herein. Algorithms, procedures, routines, or programs as described herein in this application may also be included as variants of the portable application and security mechanism.

Below, an example process of and apparatus to provide a transactional widget is described. The Intelligent Transactional Widget may contain code scripted to permit self-contained transactions on a website without leaving the website. Thus, the Transactional Widget may contain code scripted to permit secure transactions within a website without leaving to go to another website. The Intelligent Transactional Widget provides an advantage over current industry standard advertising solutions because it provides information within the widget which enables a more intelligent matching of (advertisers) products with likely consumer opportunities targeted by current Ad Serving Solutions. The Intelligent Transactional Widget may permit an advertiser or Media space owner to populate the transactional widget with product(s) by selecting from a digital library of available offerings. The selection of products to be included in the Intelligent Transactional Widget can be limited to a single product, multiple products offered by multiple sellers, multiple products offered by a single seller or any other combination of products. Alternatively or in combination with other aspects of an embodiment the Transactional Widget may contain code scripted to permit transactions within or inside an online advertising space within another website without leaving the other website. The following drawings and text describe various example implementations.

The Transactional Widget may contain code scripted to permit transactions, in the transactional widget ad model, to be carried out inside the transactional banner presented by the widget, customers of online e-commerce sites remain within the original site; and/or users to securely buy products and services from a seller without interrupting their overall experience. The widget may also have code scripted to interact with a number of secure payment providers. The customers may use any number of payment options including general payment options such as credit cards or more proprietary methods such as Pay Pal. The code for the secure payment tunnels may be scripted within the widget platform itself and can be easily updated by the owner of the widget. The Transactional Widget may alternatively or in combination contain code scripted to permit creating template instances of a platform hosting the widget application with a user interface that allows customers to build a custom content widget from that base template. The transactional widget may let the user interact with an eCommerce application on a web page, for example to buy products, book services or download digital content from your company, completely within the transactional banner presented by the widget.

The widget may be a portable chunk of code that can be installed and executed within any separate HTML-based web page by an end user without requiring additional compilation. The transactional widget may be a module, snippet, plug-in or extension form that adds some advertisement content to that page that is not static and the content may be changed by someone other than the owner of the web page and may be run when the page is called.

In one embodiment, the Transactional Widget may give internet users the ability to purchase physical or digital products from anywhere on the web without having to leave that website they are on. This may have many benefits, in particular, it attracts advertisers that pay on a CPA basis to affiliate with such a new trend of advertisement. The Transactional Widget may represent a paradigm shift in online display advertising in a traditional online marketplace. Such a widget may allow purchase of any product or service currently sold and purchased online. In particular, digital goods may benefit from real-time transaction and delivery without leaving the site.

In an embodiment where a client side API sends an initial authorization request from the client to the API request authentication module within the portable application, such as an intelligent transactional widget. The API request authentication module may communicate with the creation source of the portable internet application. The portable internet application can include backend systems, services and database to do a database look up and check.

One example an authentication sequence for an implementation that might include a trusted third party brand/auditing vendor who participates in creating a security seal for trusted publishers using portable application. Such vendor could participate in a three-way handshake and authentication.

Some portions of the detailed descriptions above are presented in terms of algorithms and symbolic representations of operations on data bits within a computer memory. These algorithmic descriptions and representations are the means used by those skilled in the data processing arts to convey the substance of their work to others skilled in the art most effectively. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These routines, algorithms, etc. may be written in a number of different programming languages. Also, an algorithm may be implemented with lines of code in software, configured logic gates in software, or a combination of both. The portable application and its security mechanisms may be scripted in any number of software program languages.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While some specific embodiments of the invention have been shown, the invention is not to be limited to these embodiments. The invention is to be understood as not limited by the specific embodiments described herein, but only by the scope of the appended claims.

What is claimed is:

1. An apparatus, comprising:
a first internet application hosted on a source server and stored on a physical storage medium of the source server, where the internet application is served across a network onto a client machine, where the internet application contains code scripted to temporarily install on the client machine;
the internet application shell container contains code scripted for:
a user interface to solicit sensitive data from a user of the client machine;
a dual encryption security system including:
an encryption engine for a cryptographic protocol that provides security for communications over networks by encrypting transmitted data from the communication,
a security communication manager employing an encrypted protocol where the identity of both a sender and a receiver of the transmitted data are both authenticated, where the authentication between the client and source server is bilateral, the authenticity of the source server identity deploying the internet application to a client browser is authenticated as an authorized source server identity, and the integrity of the internet application as displayed in the client browser on the client machine is authenticated by the source server;
wherein the security communication manager is further configured to transmit the solicited sensitive data from the user interface by cooperating with the encryption engine in according to the dual encryption security system that ensures the integrity of the client-server communication steps and data collection processes between the internet application and the authentication source by preventing at least identity theft and fraudulent activity and wherein the systems allows a mechanism for embedding a secure communications with and identity of an embeddable internet application on an unsecure website.

2. The apparatus of claim 1, where users need to install a software framework using the client machine's operating system before launching the internet application, which downloads, updates, verifies, and executes the distributed portable internet application, and a client portion of the internet applicant resides within a special isolated area of the client machine called a browser security sandbox, the browser security sandbox limits visibility and access to a file-system and the operating system on the client machine to the source server on the other side of the connection; thus allowing the client machine to handle local activities, calculations, and reformatting, thereby lowering the amount and frequency of client-server traffic.

3. The apparatus of claim 1, where the apparatus authenticates that the internet application was delivered to the client browser from an authentic source, verifies the integrity of the internet application as displayed in the client browser, and where the apparatus authenticates the communication steps and data collection processes between the internet application and the authentic source, and wherein the internet application is communicated through an API and the API has security controls consistent with non-portable applications.

4. The apparatus of claim 1, where a client side API sends an initial authorization request from the client to an API request authentication module within the internet application, including an intelligent transactional widget; the API request authentication module communicates with the creation source of the distributed portable internet application including backend systems, services and database to do a database look up and check and wherein an authentication sequence for an implementation that includes a trusted third-party brand or auditing vendor who participates in creating a security seal for trusted publishers using the distributed portable internet application; and wherein such a vendor participates in a three-way handshake and authentication.

5. The apparatus of claim 1, wherein:
the source server implementing the distributed portable internet application accepts a request from any client browser to deliver the distributed portable internet application as part of the HMTL document and includes a routine to perform the one-time hash match through a protocol that verifies both the identity of the source server and client machine and subsequent look up in the memory of the security server, the apparatus authenticates that the internet application was delivered to the client browser from an authentic source;
the client machine's web browser sends a client browser request for another portion of the internet application to the processing platform creating instances of the internet application, the processing platform sends a dynamically generated a portable internet application with a single use hash embedded to the client machine's web browser, the internet application self generates its own unique signature to unlock the executable code of the internet application via unreadable metadata sent with the internet application and the self generated unique signature will match up to a valid signature stored in a table in the server;
the internet application:
self generates its own unique signature to unlock the executable code of the portable internet application via unreadable metadata sent with the portable internet application and the self generated unique signature will match up to a valid signature stored in a table in the server, wherein a random key generator sends a unique signature along with the executable code of the portable internet application to unlock the executable code of the portable internet application and the issued generated unique signature will match up to a valid signature stored in a table in the server, the self generated key or issued randomly generated key harden the binary code for authentication of the portable internet application to ensure no one has altered the code of the portable internet application,
sends an initial communication to the server for an authentication match, such source creates two unique hash keys;
and wherein the apparatus verifies the integrity of the internet application as displayed in the client browser, upon a successful match, the processing platform also pushes a dynamically generated single use public key plus several requester's data objects asynchronously to one or more third party security vendors or a security server.

6. The apparatus of claim 5, wherein:
asynchronously, such source creating instances of the portable internet application dynamically incorporates one key into the portable internet application and securely sends the other key to a respected third-party brand or audit vendor;
upon the execution or compilation of the portable internet application on the client browser, the portable internet application submits to the third-party the hash key, which is authenticated against the key provided by the source;
the client machine's web browser sends a portable internet application request verification by passing the one time use hash function to the server system or the third party security vendors, the server system or the third party security vendors then communicate that the security vender was able to verify the hash and thus is authentic and authorizes secure data objects to the processing platform.

7. The apparatus of claim 6, wherein:
upon a successful match of the sender and receiver ID's via an SSL protocol, the server system or third-party security vendor performs two functions:
first, the server system or the third-party security vendor issues a key that provides a missing component of code or that in turn enables the portable internet application to complete an argument or routine that enables the portable internet application to perform properly. In both cases, the portable internet application has the address of the security server to call to and establish SSL tunnel type communications with,
secondly, the server system or the third-party issues a certification or other visual representation that the transaction is indeed certified as secure, the processing platform then passes encrypted data objects back and forth between itself and the client machine's web browser to complete the transaction in secure communication channels.

8. The apparatus of claim 7, wherein:
upon a successful match of the sender and receiver ID's via an SSL protocol, the server system or third-party security vendor performs two functions:
first, the first internet application generates its own signature key, authenticates, and reloads in the memory used by the browser, and then sends its initial communication to the security server for verifies the integrity of the first internet application as displayed in the client browser,
secondly, the server system or the third-party issues a certification or other visual representation that the transaction is indeed certified as secure, the processing platform then passes encrypted data objects back and forth between itself and the client machine's web browser to complete the transaction in secure communication channels.

9. The apparatus of claim 1, where the security communication manager uses a Secure Socket Layer communication protocol and the encryption engine uses an RSA encryption public-private key mechanism and wherein only the user sensitive data is passed as encrypted data objects in order to increase speed of communications between the server and the client, regular public information is not encrypted by an RSA type of encryption program, thus, the apparatus authenticates the communication steps and data collection processes between the first internet application and the authentic source.

10. The apparatus of claim 1, where the transmitted object from the server that will be complied at runtime into the internet application generates a unique signature or key that is derived from 1) embedded metadata, 2) by being reloaded in the browser after the object is complied, and 3) any combination of both so that the signature can be matched by list of unique signature or keys stored in the server; and wherein the signature can unlock the executable file of a portable application.

11. The apparatus of claim 1, where the internet application verifies a self generated signature including what that signature is supposed to be to unlock the executable portion of that the portable internet application in the browser of the client device; SSL verifies the identities of the security server and the client device; the portable internet application also sends its self generated unique signature to the security server to be verified; if these do not match, then the communication does not proceed; during communications between the portable internet application and the secure server, RSA type of encryption is used to further secure sensitive data transmitted over the network.

12. The apparatus of claim 1, where a third party vendor is involved in a the validation, and wherein due to the dual security system employed in the communications between the portable application and the secure server, intelligence routines are built into the portable application, once authenticated and verified and validated, the application calls the secure server on any number of possible reasoning task and receive guidance from the secure server, and wherein the secure server includes a list of authorized servers and wherein the security communication manager uses a Secure Socket Layer communication protocol and the encryption engine uses blowfish encryption.

13. A method for securing internet applications comprising:
providing a first internet application hosted on a source server and stored on a physical storage medium of the source server, where the internet application is served across a network onto a client machine, where the internet application contains code scripted to temporarily install on the client machine;
the internet application shell container contains code scripted for:
a user interface to solicit sensitive data from a user of the client machine;
a dual encryption security system including:
an encryption engine for a cryptographic protocol that provides security for communications over networks by encrypting transmitted data from the communication,
a security communication manager employing an encrypted protocol where the identity of both a sender and a receiver of the transmitted data are both authenticated, where the authentication between the client and source server is bilateral, the authenticity of the source server identity deploying the internet application to a client browser is authenticated as an authorized source server identity, and the integrity of the internet application as displayed in the client browser on the client machine is authenticated by the source server;
wherein the security communication manager is further configured to transmit the solicited sensitive data from the user interface by cooperating with the encryption engine in according to the dual encryption security system that ensures the integrity of the client-server communication steps and data collection processes between the internet application and the authentication source by preventing at least identity theft and fraudulent activity and wherein the systems allows a mechanism for embedding a secure communications with and identity of an embeddable internet application on an unsecure website.

14. The method of claim 13, where further comprising installing a software framework using the client machine's operating system before launching the internet application, which downloads, updates, verifies, and executes the distributed portable internet application, and a client portion of the internet applicant resides within a special isolated area of the client machine called a browser security sandbox, the browser security sandbox limits visibility and access to a file-system and the operating system on the client machine to the source server on the other side of the connection; thus allowing the client machine to handle local activities, calculations, and reformatting, thereby lowering the amount and frequency of client-server traffic.

15. The method of claim 13, further comprising authenticating that the internet application was delivered to the client browser from an authentic source, verifies the integrity of the internet application as displayed in the client browser, and where the apparatus authenticates the communication steps and data collection processes between the internet application and the authentic source, and wherein the internet application is communicated through an API and the API has security controls consistent with non-portable applications.

16. The method of claim 13, where a client side API sends an initial authorization request from the client to an API request authentication module within the internet application, including an intelligent transactional widget; the API request authentication module communicates with the creation source of the distributed portable internet application including backend systems, services and database to do a database look up and check and wherein an authentication sequence for an implementation that includes a trusted third-party brand or auditing vendor who participates in creating a security seal for trusted publishers using the distributed portable internet application; and wherein such a vendor participates in a three-way handshake and authentication.

17. The method of claim 13, further comprising:
implementing the distributed portable internet application accepts a request from any client browser to deliver the distributed portable internet application as part of the HMTL document and includes a routine to perform the one-time hash match through a protocol that verifies both the identity of the source server and client machine and subsequent look up in the memory of the security server, the apparatus authenticates that the internet application was delivered to the client browser from an authentic source;
sending a client browser request for another portion of the internet application to the processing platform creating instances of the internet application, the processing platform sends a dynamically generated a portable internet application with a single use hash embedded to the client machine's web browser, the internet application self generates its own unique signature to unlock the executable code of the internet application via unreadable metadata sent with the internet application and the self generated unique signature will match up to a valid signature stored in a table in the server;
wherein the internet application:
self generates its own unique signature to unlock the executable code of the portable internet application via unreadable metadata sent with the portable internet application and the self generated unique signature will match up to a valid signature stored in a table in the server, wherein a random key generator sends a unique signature along with the executable code of the portable internet application to unlock the executable code of the portable internet application and the issued generated unique signature will match up to a valid signature stored in a table in the server, the self generated key or issued randomly generated key harden the binary code for authentication of the portable internet application to ensure no one has altered the code of the portable internet application,
sends an initial communication to the server for an authentication match, such source creates two unique hash keys;
and verifying the integrity of the internet application as displayed in the client browser, upon a successful match, the processing platform also pushes a dynamically generated single use public key plus several requester's data objects asynchronously to one or more third party security vendors or a security server.

18. The method of claim 13, wherein:
asynchronously, such source creating instances of the portable internet application dynamically incorporate one key into the portable internet application and securely sends the other key to a respected third-party brand or audit vendor;
upon the execution or compilation of the portable internet application on the client browser, the portable internet application submits to the third-party the hash key, which is authenticated against the key provided by the source; and
the client machine's web browser sends a portable internet application request verification by passing the one time use hash function to the server system or the third party security vendors, the server system or the third party security vendors then communicate that the security vender was able to verify the hash and thus is authentic and authorizes secure data objects to the processing platform.

19. The method of claim 18, wherein:
upon a successful match of the sender and receiver ID's via an SSL protocol, the server system or third-party security vendor performs two functions:
first, the server system or the third-party security vendor issues a key that provides a missing component of code or that in turn enables the portable internet application to complete an argument or routine that enables the portable internet application to perform properly. In both cases, the portable internet application has the address of the security server to call to and establish SSL tunnel type communications with,
secondly, the server system or the third-party issues a certification or other visual representation that the transaction is indeed certified as secure, the processing platform then passes encrypted data objects back and forth between itself and the client machine's web browser to complete the transaction in secure communication channels.

20. The method of claim 19, wherein:
upon a successful match of the sender and receiver ID's via an SSL protocol, the server system or third-party security vendor performs two functions:
first, the first internet application generates its own signature key, authenticates, and reloads in the memory used by the browser, and then sends its initial communication to the security server for verifies the integrity of the first internet application as displayed in the client browser,
secondly, the server system or the third-party issues a certification or other visual representation that the transaction is indeed certified as secure, the processing platform then passes encrypted data objects back and forth between itself and the client machine's web browser to complete the transaction in secure communication channels.
